(19) United States
(12) Patent Application Publication
(10) Pub. No.: US 2006/0265293 A1
(43) Pub. Date: Nov. 23, 2006

(54) Method of labeling citrus fruit and tracking customer preferences

(76) Inventor: Christopher Edward Bengyak, Vero Beach, FL (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 11/417,752

(22) Filed: May 3, 2006

Related U.S. Application Data
(60) Provisional application No. 60/677,314, filed on May 3, 2005.

(51) Int. Cl. G07F 7/00

(52) U.S. Cl. 705/28

(57) ABSTRACT

A method of labeling citrus fruit and tracking customer preferences requires measuring the external appearance and internal taste characteristics for each piece of fruit, placing such information on a label affixed to each piece of fruit, and tracking customer buying preferences. Customer selection choices are also enhanced by education in the form of guides to understanding the information placed on the labels. By labeling fruit and educating consumers, utilization of citrus industry resources may be enhanced.

### CROSS REFERENCE TO RELATED APPLICATIONS

This application claims the benefit of provisional patent application Ser. No. 60/677,314, filed May 3, 2005, by the present inventor

### BACKGROUND

### Field of Invention

This invention is a marketing model for the Fresh Citrus industry. This marketing model focuses on issues of standardization and on the utilization of taste scale signs and a multiple labeling system to track how many peel defects the public will accept in the name of taste.

Currently, there is excessive over-grading plaguing the Florida citrus industry due to buyers' intense focus on procuring “pretty” fruit. Under such high grade standards, too many delicious citrus with relatively minor blemishes are being juiced because they're not “pretty” enough. This is especially disconcerting when one sees that pretty but much less flavorful fruit are packing at very high packout percentages. These issues must be corrected.

At the heart of this irrational buyers' procurement strategy is a problem of information. Currently, there is no marketing strategy that will enable the industry to assess how much satisfaction the public derives from appearance, and how much from taste. For example, it is fairly obvious which fruit the public would choose when given the choice of two equally pretty fruit but with one that was slightly better tasting. But, how would that choice be affected if the appearance of the better tasting fruit was slightly marred by a scar? How would the choice change if the slightly better tasting fruit had several scars on it? How about by many scars and discoloration? Just how much peel defects would it take before the public chooses the fruit of lower internal quality?

Providing an objective method to acquire this information is the key to correcting the many inefficiencies of the Florida citrus industry's grading and procurement processes. A marketing strategy that is designed to acquire this information objectively is possible. The key is to design business processes so that the public can choose between certified variations of taste and appearance and so that retailers can easily track these purchasing decisions. This whole process can be thought of as being composed of two ideas, a certification system and a feedback system. Certification involves shippers organizing fruit into several tiers of taste standards through tests of internal quality.

A multiple labeling system involves a chart and a multiple labeling system. These tools enable the public to systematically choose between taste and appearance and enables retailers easily to track these purchasing decisions. Current marketing models fail to provide necessary certification and feedback systems to reveal consumer preferences.

### SUMMARY OF THE INVENTION

This invention provides a marketing and business method specifically designed to acquire information about the market to achieve superior business results. This method is based on the concept of marginal analysis and will enable the industry to objectively determine how low a grade of citrus fruit can be packed in the name of taste. The plan is organized around two main ideas—Certification and Feedback.

Certification requires that the global market be supplied with fruit organized in tiers based on taste and at distinctions that can be appreciated by customers. This is done by defining several tiered standards of internal quality above current minimum maturity standards. A model having four tiers is proposed, although any number can be used. A sampling plan is used to test internal quality (or utilize a brix sensor machine accompanied with sampling plan for acidity testing). Fruit will be packed according to varying degrees of appearance and by taste standards.

The goal of feedback is to establish a multiple labeling system and chart that will enable the public to systematically choose between variations of taste and appearance, and create the visibility necessary for retailers to track purchasing decisions. The steps to achieving adequate feedback include designing taste scales that describe the ranges in taste of internal quality; delivering taste scales to supermarkets and retailers to be positioned next to citrus being displayed to educate the public of the differences in internal quality; place multiple decal stickers upon fruit being displayed with each sticker representing a distinct taste that corresponds to the specified internal quality standards; label each fruit from each taste tier with the respective decal sticker; and encode information such as (brix level, grade, variety) into the barcodes of the decal stickers.

This method is designed to reveal just how much peel defect the public is willing to accept on each tier level before choosing a less flavoursome but prettier piece of fruit. In this manner the supply of Florida's best tasting fruit can be maximized for individual purchases.

### BRIEF DESCRIPTION OF THE DRAWINGS

FIG. 1 is a four quadrant chart showing marketing strategies

FIG. 2 shows citrus pieces organized by taste and appearance

FIG. 3 is a taste scale and multiple corresponding stickers.

FIG. 4 shows a graph depicting taste characteristics of sweetness and tartness

FIG. 5 is a chart showing an intensity taste scale.

FIG. 6 is a form of flavor scale and multiple corresponding stickers

FIG. 7 shows a form of marking individual pieces of fruit with taste and appearance.

FIG. 8 shows a consumer-oriented “key” used to explain fruit characteristics.

### DETAILED DESCRIPTION OF THE PREFERRED EMBODIMENTS

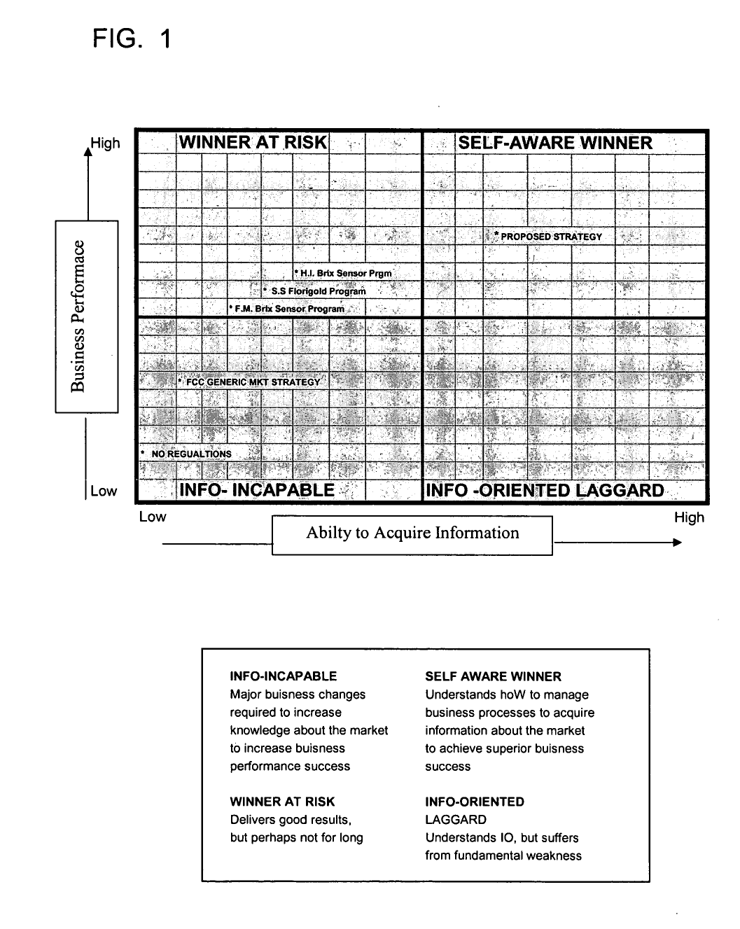

FIG. 1 is a four quadrant chart showing a correlation between the citrus industry's actual or hypothetical business performance and the market's ability to acquire information. The lower left quadrant (“Info-Incapable”) represents a market in which the industry's ability to acquire information is low and, because of existing standards, business performance is substantially below the optimum. The upper left quadrant (“Winner at Risk”) represents a better business model in which market performance can be enhanced—yet, continues to remain below optimum performance because of a lack of information and feedback from consumers. The lower right quadrant (“Info-Oriented Laggard”) is largely irrelevant, as it represents a market in which consumer preferences are known, yet performance is low, presumably due to growers' and commercial buyers' failure to provide consumers with desirable choices. The upper, right quadrant (“Self-Aware Winner”) represents the situation in which an abundance of information results in strong market performance. The goal of this invention is to provide both the information necessary to determine consumer preferences and the means for growers and fruit buyers to utilize that information to make those preferences available to consumers.

The “Info-Incapable” quadrant represents the existing state of the Florida citrus market as it is currently performing under the Florida Citrus Commission's generic marketing strategy. This strategy requires packers and shippers to adhere solely to legally required minimum quality standards. In this marketing model, each lot of Florida citrus shipped as fresh fruit is inspected for two standards—External grade (what the fruit “looks” like); and minimum internal quality. The grade standards ensure that acceptable external conditions are met for the fruit to reach the market. The minimum internal quality standard prevents immature fruit from reaching the market.

Currently this marketing model is forcing Florida citrus growers to compete primarily on the basis of external appearance, a strategy which leaves growers not only unable to capitalize on their best tasting fruit, but which also promotes extreme cases of over-grading. Because this model places undue emphasis upon external appearance, much great tasting fruit is going to the juice cannery because of minor skin blemishes, while blemish free fruit having relatively poor internal quality is being packed out at high percentages. This causes first grade, low ratio fruit to fetch much higher prices than second grade, high ratio fruit. Under these conditions, the industry may be incurring enormous opportunity costs associated with not providing the type of fruit the public would desire most if it were properly informed.

In a generic marketing strategy where the supply of Florida citrus is not organized by taste and where there is no reliable labeling system to inform the public of internal quality, the value of taste is effectively hidden. This means consumers can't choose between appearance and taste. Thus, for consumers, this uncertainty of internal quality results in a reliance on appearance for the basis of selection; and, when appearance is the only basis for selection, the public will choose the prettiest fruit. Under these conditions, inferences regarding the public's preferences for taste and appearance are rendered invalid, and there can be no objective feedback of public preferences.

Without an objective method to measure the value the public assigns to peel condition or to taste, the grading and procurement processes are relegated to the subjective measure of the grower's opinion regarding public preferences. Thus although growers may believe that external appearance plays a subordinate role in marketing commercial fruit, fruit buyers believe that it plays a more critical role. Currently, commercial buyers justify their high grade demands by pointing at market signals of the public scrutinizing peels and picking the prettiest fruit.

Clearly, these distorted market signals pose a serious threat to the growers. When viewing these market signals in the context of a market system in which all market participants are motivated by self interest (profit), these signals distort the incentives which are key to an efficient market. When buyers are rewarded for procuring pretty fruit, and only pretty fruit, they will continue to do so regardless of the devastating effects it has on the growers and the industry as a whole. Under these conditions, the industry is incurring enormous opportunity costs associated with not providing the type of fruit the public desires most.

Marketing models in the “Winners at Risk” quadrant are comprised of those who have augmented their marketing strategy by adding additional taste standards beyond the minimum maturity requirements. These models are currently delivering good business results, but because of fundamental weaknesses in the model, will not prevent excessive over-grading in the future.

In an industry where most packing houses do not organize their citrus by brix levels, marketing citrus by certifying brix internal quality standards, has enabled models in this quadrant to exceed the business performances of conventional models. Examining these models highlights the fact that certification counts, and that what you measure makes a huge difference in how a product is viewed. Regulating and certifying fruit by brix levels has enabled these models to institute additional brix charges and attract consumers by supplying a stable supply of sweet fruit. With these moves toward more aggressive regulation for internal quality, these models have significantly enhanced brand recognition by signaling to the market a consistent, stable supply of sweet fruit.

As opposed to the Info-Incapable model, Winners at Risk are delivering some success in the market now. However, these models are at severe risk of losing their competitive edge, and there is nothing in the model to prevent excessive overgrading in the future. The marketing tactic of organizing a supply of citrus by brix levels alone will not prevent long term excessive over-grading as it provides no effective feedback system whereby consumers can choose between varying degrees of taste and appearance, and whereby retailers can easily track consumers' purchasing decisions.

Currently, each operator using this model affixes identical decal stickers (that refer only to program's brand name or logo) on all fruit in the taste program. Other than compiling gross sales information, this practice provides no effective feedback. Closer examination of these models show that despite the markets positive reaction to better tasting fruit, these new innovative marketing programs have failed to reveal to the buyers the importance of the incremental relationship between taste and appearance. A distinction must be made between a models' ability to force buyers to accept lower grades simply because they are in an environment where few organize fruit by taste and a models' ability to objectively reveal how low of a grade the public will accept on each taste tier level.

Without this feedback these programs are breeding buyers who want both taste and appearance. The success of operators using this model has been tempered by a constant pressure to increase grade. Already, the brix censor grade has been forced upwardly from its original standard. The taste standards emerging beyond minimum maturity are based on brix levels alone. As more brix censor machines and more brix level based programs are introduced into the industry, the marketing model of grading brix alone will do nothing to prevent the kick start of another grading competition.

This current brix level standard is not the best standard for taste, mainly because it ignores the critical role acid plays in taste. For instance, without preset maximum acidity levels, even fruit at the highest brix level tiers may have an overpoweringly high acidity level that leaves the negative and lasting impression of a very bitter and sour taste. Not controlling this is a serious mistake, because it will chip away at the confidence the consumer would have for the credibility of the taste program. An effective program must take into consideration the dramatic effects that very high and very low acid levels have on taste.

Ranges of taste standards must be structured to maximize grower profits. Existing programs have deficiencies that prevent profit maximization. For example, the standard range of one operator's existing program is not strategically set to allow maximum profitability for growers. The weakness in the model is that there is no further differentiation of taste beyond the 10+ brix level. Because there is a definite distinct difference in taste between, for example, a 10+ brix versus a 12+ brix fruit, the opportunity for testing the market's tolerance in grade for 12+ brix fruit is lost by not differentiating further.

Similarly, a program that sets only one range distinction misses out on maximizing the market's grade concession. For example, in a model that sets a high 11+ brix range, any fruit that falls elow 11+ will be graded as harshly as conventional grade. On the other hand, a more useful program divides the supply of fruit into several taste ranges, e.g., minimum maturity, 10+ 10.5+ 11+ and 12+. Making several distinctions in taste allows a program to capitalize on several variances of taste.

In addition to differentiating fruit by taste, a successful marketing model must also be able to track purchases by external appearance. The current practices of combining first and second grades fruit into one low grade, results in an unorganized supply by appearance. This makes it extremely difficult to implement a feedback system that can monitor marginal utility gained or lost by incremental changes in taste and appearance. To say it in another way, taste programs in which the majority of the fruit packed is in a combination grade will find it extremely difficult to reveal just how low of a grade, Oust how much scarring and other peel defects) the public is willing to tolerate on each brix tier level before choosing a less flavorsome but prettier piece of fruit.

A combining of grades has another drawback to establishing a convincing feedback system. When consumers are confronted with a selection of 1st and 2nd grade fruit of the same brix levels, consumers will normally pick out the prettiest fruit. Clearly, a taste program does not want to mislead retailers' appraisal of consumers' preferences with mixed signals. Rather, the program should focus retailers' attention on the fact that second grade, high ratio fruit is moving faster than 1st grade lower ratio fruit. To accomplish this there must be a consistency in supply. Thus, the supply of citrus must be organized by appearance also.

The most critical component of a feedback system is how fruit are labeled. Currently, most operators affix identical decal stickers (that refer only to program's brand name or logo) on all fruit in the taste program, regardless of the operator's internal quality standard. Although this is great for attracting attention to the program, this tactic alone will not support an effective marketing program nor a feedback system.

Identical undifferentiated stickers do not account well for supermarkets ordering and stocking practices. It is standard practice for supermarkets to re-order fruit before inventory is totally depleted. Because of fluctuations in availability, the supermarkets may not consistently be able to obtain fruit that matches their pre-existing supply. Consequently, normal re-ordering and stocking practices will lead up to overlaps,—that is, to mixtures of—for example, 12+ brix fruit from the previous supply and 10+ brix fruit from the new supply, on the same shelves or in the same bin. With identical stickers, it's impossible for the consumer to distinguish which is which. Identical (undifferentiated) stickers not only compromise the consumer's selection, but they chip away at the consumer's perception of the certification system, and distort feedback results.

Another disadvantage of affixing identical stickers with only the program name on it or a logo, is that identical stickers do not maximize the advertising potential of the program. Although the program name or a logo stamped on the decal helps the consumers remember the name of the program, the lack of information on the stickers regarding the fruit's respective internal-quality lessens the effectiveness of the stickers and lessens the overall focus on differences in taste.

The “Self-Aware Winner” quadrant of FIG. 1 represents the marketing model that comprises the invention. In this quadrant, high business performance results from the systematic collection of detailed information coupled with appropriate standards for packaging and with consumer education based upon fruit labeling and a “key” that is available to explain labeling categories. This model requires a testing method that assures a high probability that consumers can pick out fruit that is of the promoted taste standards. For the industry to use the sampling plan to promote internal quality by tiered standards, the results of the sampling plan must be more accurate and more stable than the sampling plan currently designed to test simply for minimum maturity. This means designing high confidence levels and tight confidence intervals, and using these large sample sizes throughout the season.

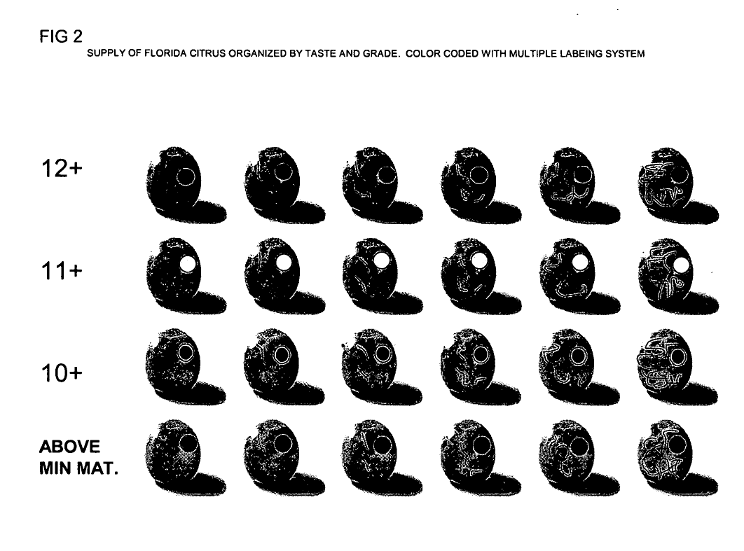

FIG. 2 depicts variety of fruit having different internal taste measurements (in this case, brix) and a variety of external appearances. While it would initially be expected that consumers choosing a piece of fruit would first select a piece of fruit having an unblemished or only slightly blemished skin, customers who become educated in the methods of this invention will reach a point at which they will choose fruit having a blemished skin rather than choosing better looking fruit having a lower taste indicator. For purposes of determining consumer preferences as they mature within this technology, it will be necessary to record and analyze both the taste ratings and the external skin ratings of a large number of sales. This can be done through labeling individual pieces of fruit as to taste and as to appearance. This can easily be done during sorting and packaging, and consumer labels placed upon individual pieces to identify taste ratings can be supplemented with bar code labels including the identity of the item (orange, grapefruit, etc.), the external appearance of the skin, and the internal taste rating. Using existing checkout equipment, accurate records of customer preferences for fruit taste and external appearance can be recorded and analyzed.

Taste in citrus fruit is determined by a combination of brix and acid levels. The industry must decide which combination is best to promote, balance or intensity. The function used in determining standards will organize fruit in a slightly different way. For example, To promote a more balanced and naturally sweet, but subdued fruit, standards should be based on a brix/acid ratio (with minimum brix levels and min/max acid levels). Since the brix acid ratio is what is highlighted, this approach, to a certain extent, minimizes the role acid plays in taste. Thus, in some cases, high brix lower acid fruit will wind up in a higher tier than fruit with high brix high acid.

To promote an intensity of zinging acid and comparable sweetness, standards should be based on designated brix and acid levels. Under this standard, the sweet and sour taste of a very high brix with high acid is favored over high brix with lower acid.

For those possessing Brix Sensor Technology, the acidity results from the sampling plan should be considered when determining standards. The combination of Brix Sensor Technology to measure brix levels and sampling plan to measure acidity content is currently the most accurate method to measure internal quality.

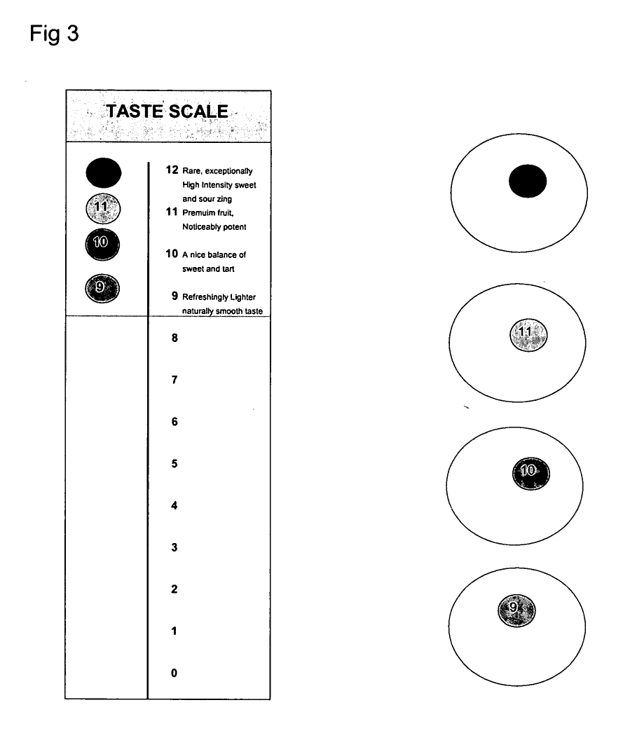

Because the taste of citrus fruit is a combination of a number of factors, various scales have been established to assist in the accurate representation of taste. Although there are legal standards applicable to the Florida citrus industry that may prevent the public offering of fruit that does not satisfy those standards, the legal standards represent minimum acceptable levels, and are not suitable for categorizing fruit on the basis of “taste.” One current scale that is used to inform consumers of the internal quality of a fruit is brix. A brix scale is depicted in FIG. 3. In FIG. 3, brix is indicated by a number that is noted on a chart explaining its meaning to consumers, and is also affixed to each piece of fruit using a label. As previously noted, citrus fruit having a high brix has received a high consumer preference. However, brix alone does not provide consumers with an indication of the tartness of a fruit, which is largely determined by the amount of acid, and brix levels without more provide little useful feedback in collecting detailed information about consumer preferences.

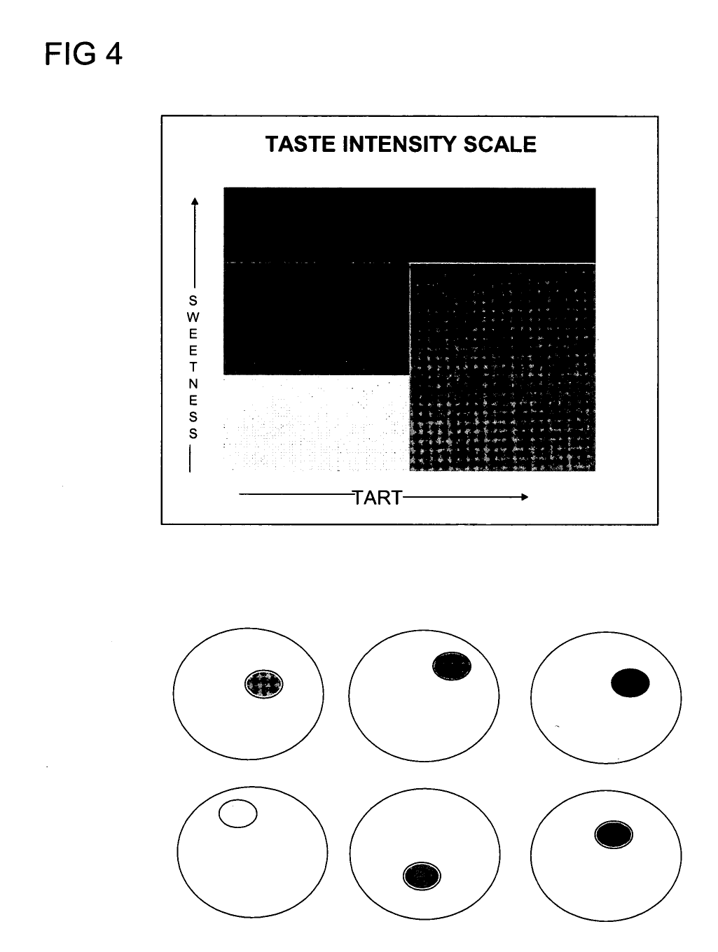

It is possible to provide a realistic predictor of the taste of a citrus fruit by analyzing both the brix and the acid of the fruit. FIG. 4A depicts an embodiment of the invention having a two dimensional scale in which brix (“sweetness”) is measured along the vertical axis, and acid (“tartness”) is measured along the horizontal axis. By superimposing a color chart between those axes, it is possible to create a color scale in which sweetness, tartness, and flavor intensity may all be represented by a color. FIG. 4B shows how labels of those colors could be used to identify fruit by those flavor characteristics. Consumers having been educated to the scale, or having a visual representation be provided at the point of selecting fruits to buy, would have confidence that they are purchasing fruit whose taste they enjoy. The scale shown in FIG. 4 may be modified to indicate brix to acid ration (BAR) along the horizontal scale. In practice, BAR provides a more useful scale in determining flavor as brix and acid are varied.

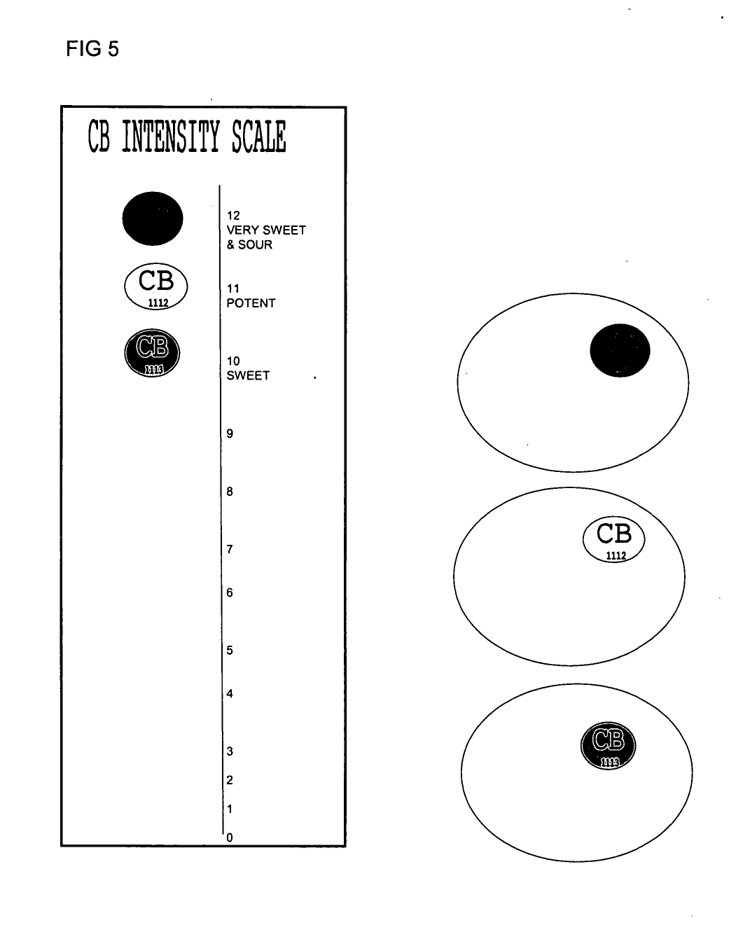

A modification of the embodiment shown in FIG. 4 is an intensity scale, depicted in FIG. 5. This scale is useful to indicate the intensity of flavor in a fruit, and would normally be an indicator of the relative levels of brix and acid (or of brix and BAR) in a selection of fruit that is neither extremely sweet nor extremely tart. The scale shown in FIG. 5 may be color coded, or may use other numerical designations to identify the intensity of flavor for each piece of fruit bearing a label. Labels may also carry trademarks of the grower or other entity having input into the selection or measurement of taste categories.

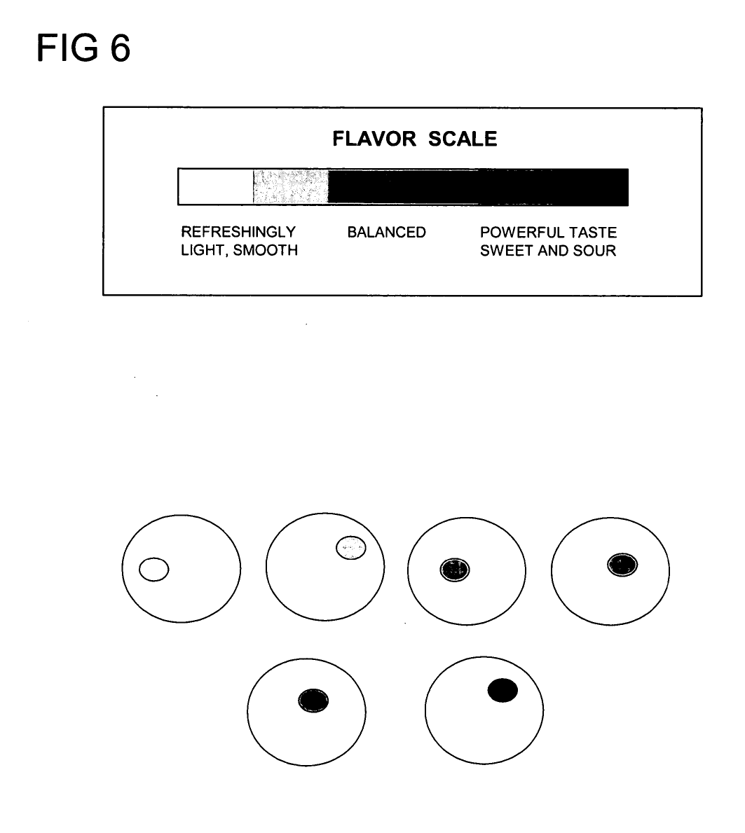

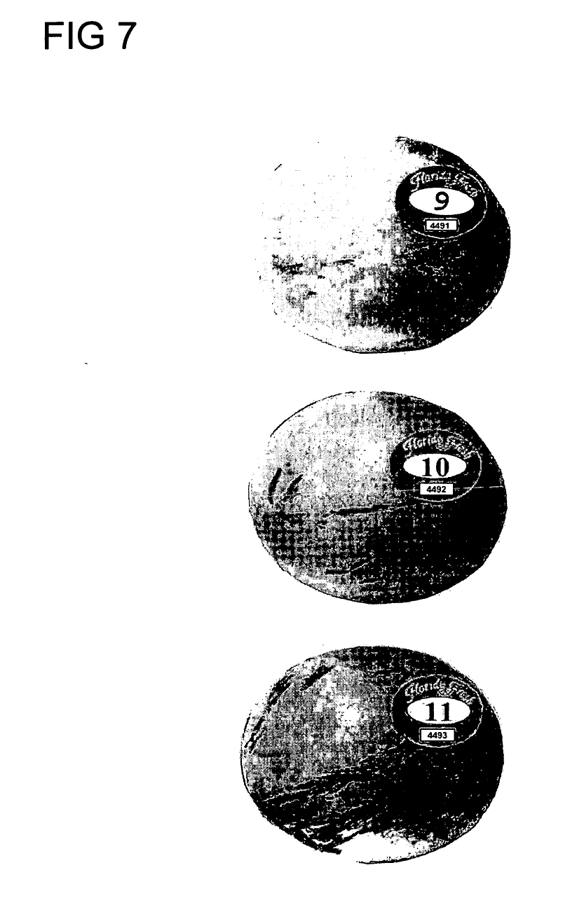

Yet another embodiment of the invention is shown in FIG. 6A, in which an arbitrary “taste scale” has been created to reflect some of the most popular consumer taste preferences. While conveying less detailed information about the taste of the fruit, a scale such as that depicted in FIG. 7A would nevertheless be useful in assisting consumers to choose desirable tasting fruit, and would provide at least some useful feedback information about consumer preferences to advance the state of the citrus marketing industry.

FIG. 7 shows a number of pieces of fruit having different external appearances and also bearing labels that identify the external grades and taste characteristics for each piece. This information assists consumers to identify and purchase those pieces of fruit having desired flavor characteristics. By recording and analyzing this information, growers and commercial buyers gain information that will assist them to accommodate consumer preferences, and that will result in greater efficiency in matching fruit to consumers who have been educated to make informed choices.

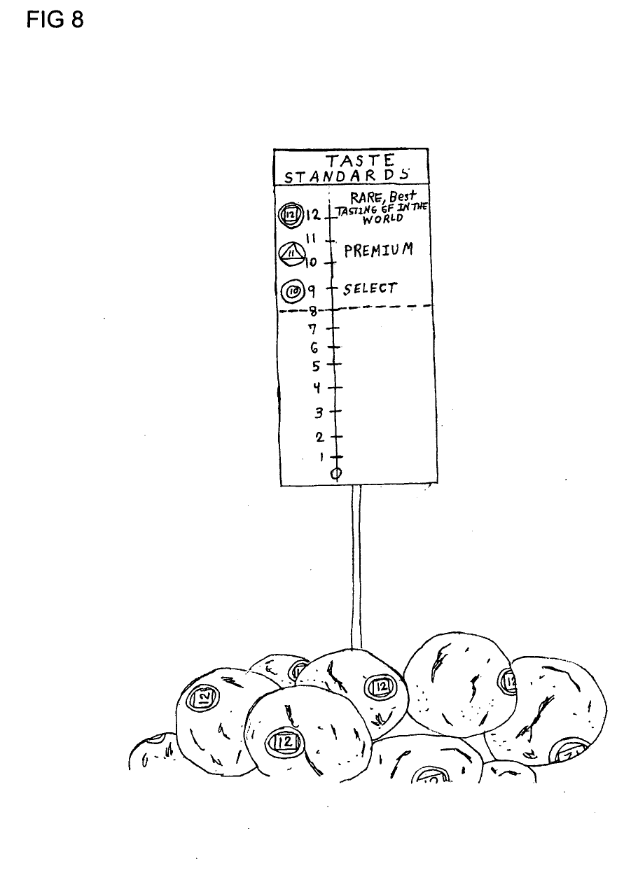

It will be appreciated that detailed taste information must be coupled with appropriate consumer education before accurate feedback will be obtained. In order to assure at least a minimal level of knowledge, fruit being offered to the public may be accompanied by a chart or other “key,” such as is depicted in FIG. 8, in which relevant information may be conveyed. As consumers' choices of citrus become better informed, they will be more willing to purchase fruit whose external appearance is less than perfect, in the expectation of enjoying a taste that is greatly to their liking. Such a development will only enhance the Florida citrus industry, and will create a better marketing environment for Florida citrus throughout the world.

I claim:

1. A method of labeling and tracking citrus fruit comprising the steps of:
(a) determining and rating the external appearance of a piece of fruit;
(b) determining taste characteristics of said piece of fruit, said determination comprising measurements of identifiable compounds including at least brix;
(c) preparing a label for affixing to said piece of fruit, said label being marked to visually display said external rating and said internal taste characteristics;
(d) affixing said label to said piece of fruit;
(e) displaying said piece of fruit to prospective purchasers.

2. A method of labeling and tracking citrus fruit as claimed in claim 1, further comprising:
(f) selling said piece of fruit;
(g) recording data included on said label, said data including at least said external rating and said measurements of identifiable compounds;
(h) repeating steps (a) through (g) until a statistically significant sample of data have been obtained;
(i) analyzing said data to determine consumer preferences.

3. A method of labeling and tracking citrus fruit as claimed in claim 2, said visual display further comprising consumer readable information regarding said external rating and said internal taste characteristics;
(j) providing a visual guide, said guide including consumer readable information regarding at least said external rating and said internal taste characteristics.

4. A method of labeling and tracking citrus fruit as claimed in claim 1, wherein said label includes an electronically readable code including information regarding said external rating and said internal taste characteristics.
